(19) United States
(12) Patent Application Publication
(10) Pub. No.: US 2014/0334096 A1
(43) Pub. Date: Nov. 13, 2014

(54) ELECTRONIC DEVICE

(71) Applicant: HON HAI PRECISION INDUSTRY CO., LTD., New Taipei (TW)

(72) Inventors: SHIH-FENG LU, New Taipei (TW); SHIANG-HUI WEI, New Taipei (TW)

(73) Assignee: HON HAI PRECISION INDUSTRY CO., LTD., New Taipei (TW)

(21) Appl. No.: 14/068,245

(22) Filed: Oct. 31, 2013

(30) Foreign Application Priority Data
May 10, 2013 (TW) 102116658

(51) Int. Cl. G06F 1/16

(52) U.S. Cl. CPC G06F 1/1656
USPC 361/679.55

(57) ABSTRACT

An electronic device includes a cover, a base, and two resilient members located in the base. The cover is rotatably connected to the base and includes first magnetic members. The base includes second magnetic members. A magnetic force results between the first magnetic members and the second magnetic members. A critical angle is defined between the cover and the base. When an angle between the cover and the base is greater than the critical angle, the cover is rotated to be in an open position by the resilient members. When an angle between the cover and the base is less than the critical angle, the cover is rotated to be in a closed position by the magnetic force.

### BACKGROUND

1. Technical Field

The present disclosure relates to electronic devices, and particularly to a notebook computer.

2. Description of Related Art

Electronic devices, such as notebook computers, comprise a base and a cover rotatably attached to the base. It can be inconvenient to rotate the cover completely open or completely closed. In addition, the cover is easily damaged by manual operations. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an electronic device in accordance with an embodiment, wherein the electronic device includes a cover.

FIG. 2 is an assembled view of the electronic device of FIG. 1, wherein the cover is in an open position.

FIG. 3 is similar to FIG. 2, but shows the cover in a middle position.

FIG. 4 is similar to FIG. 2, but shows the cover in a closed position.

FIG. 5 is a cross-sectional view taken along line V-V of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

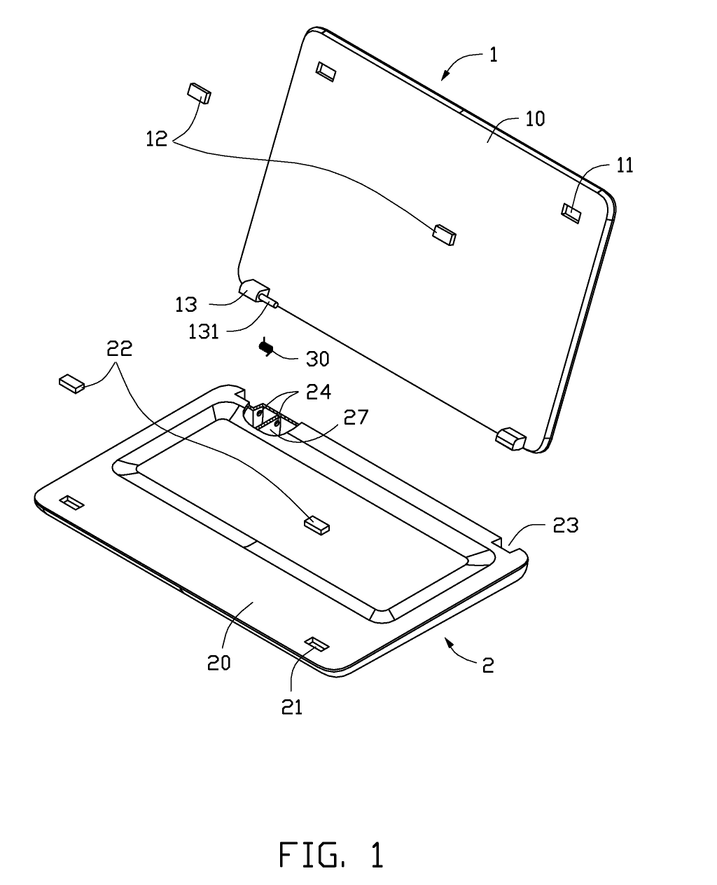

FIG. 1 illustrates an embodiment of an electronic device. The electronic device comprises a base 2 and a cover 1 rotatably attached to the base 2. In one embodiment, the electronic device is a notebook computer.

The cover 1 comprises an inner surface 10 and an outer surface 15 opposite to the inner surface 10. Two mounting portions 13 are formed at a bottom of the inner surface 10, and a mounting post 131 extends from each mounting portion 13. Two first receiving holes 11 are defined at a top of the inner surface 13 for receiving two first magnetic members 12, respectively. A size and a shape of each first magnetic member 12 are substantially equal to a size and a shape of each first receiving hole 11, such that the magnetic members 12 fill in the first receiving holes 11.

The base 2 comprises a top surface 20 and a bottom surface 25 opposite to the top surface 20. Two cutouts 23 and two pairs of securing holes 24 are defined in the base 2, and each pair of securing holes 24 communicates with a corresponding cutout 23. In one embodiment, each pair of securing holes 24 is defined in two parallel securing panels 27, and the two parallel securing panels 27 are located in an interior of the base 2. A distance between each pair of securing holes 24 is less than a length of each mounting post 131. A resilient member 30 can be secured to each mounting post 131 to be located between a pair of securing holes 24. In one embodiment, the resilient member 30 is a coil spring. Two second receiving holes 21 are defined in the top surface 20 for receiving two second magnetic members 22, respectively. A size and a shape of each second magnetic member 22 are substantially equal to a size and a shape of each second receiving hole 21, so that the second magnetic members 22 can fill in the second receiving holes 21. In one embodiment, the size and the shape of each second magnetic member 22 are substantially equal to the size and the shape of each first magnetic member 12. A magnetic pole of the second magnetic member 22 is opposite to a magnetic pole of the first magnetic member 12, so that the first and second magnetic members 22 can attract each other when they are adjacent to each other.

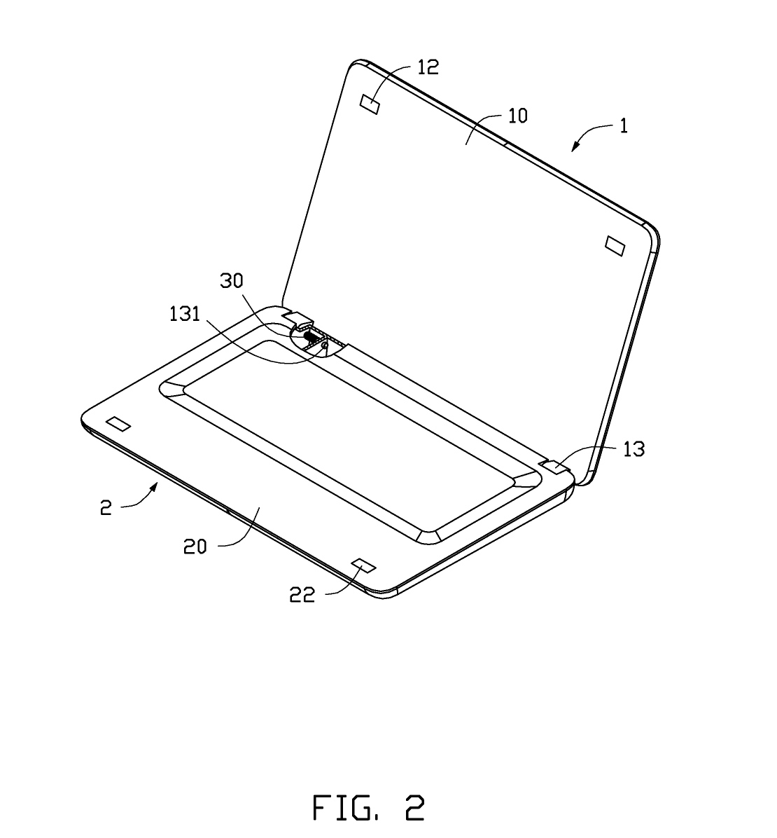

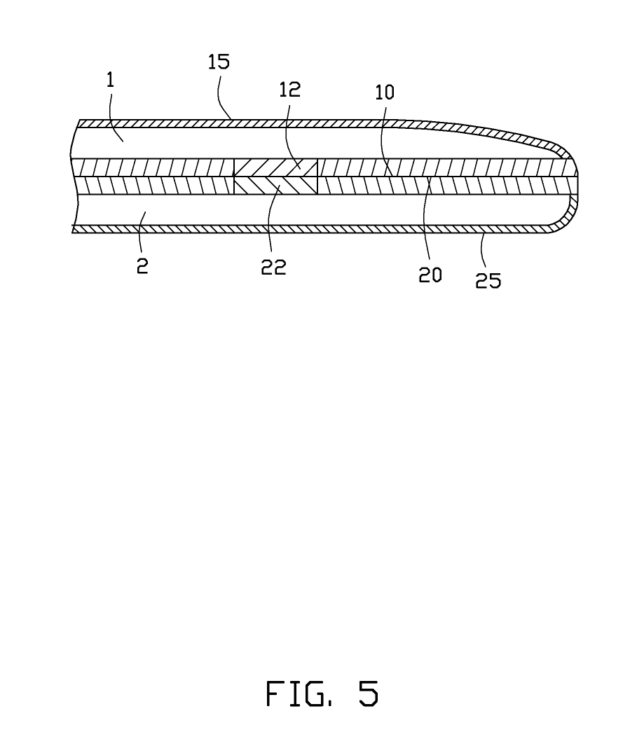

FIGS. 2-5 illustrate that in assembly, a resilient member 30 is secured on a corresponding mounting post 131. The mounting post 131 is received through a corresponding pair of securing holes 24 to rotatably secure the cover 1 to the base 2. At this time, the resilient member 30 is located between a corresponding pair of securing holes 24. In one embodiment, an axis of the resilient member 30 is substantially parallel to the top surface 20.

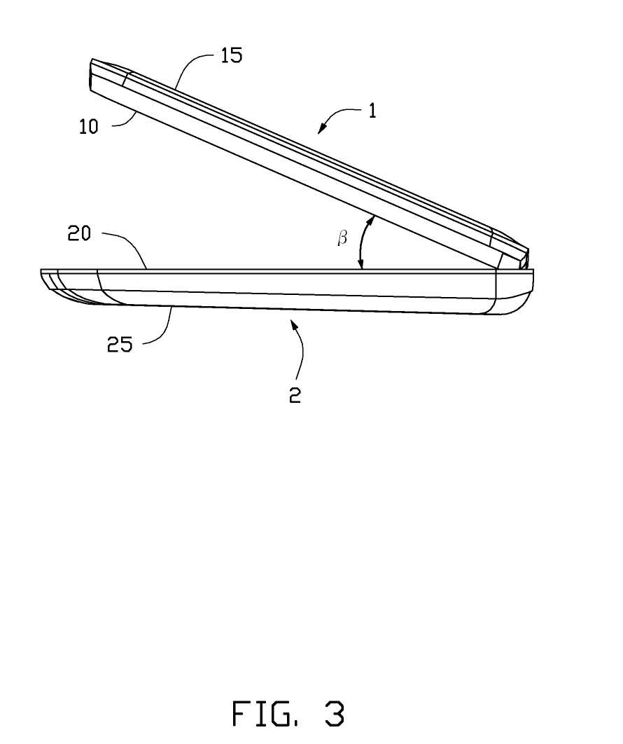

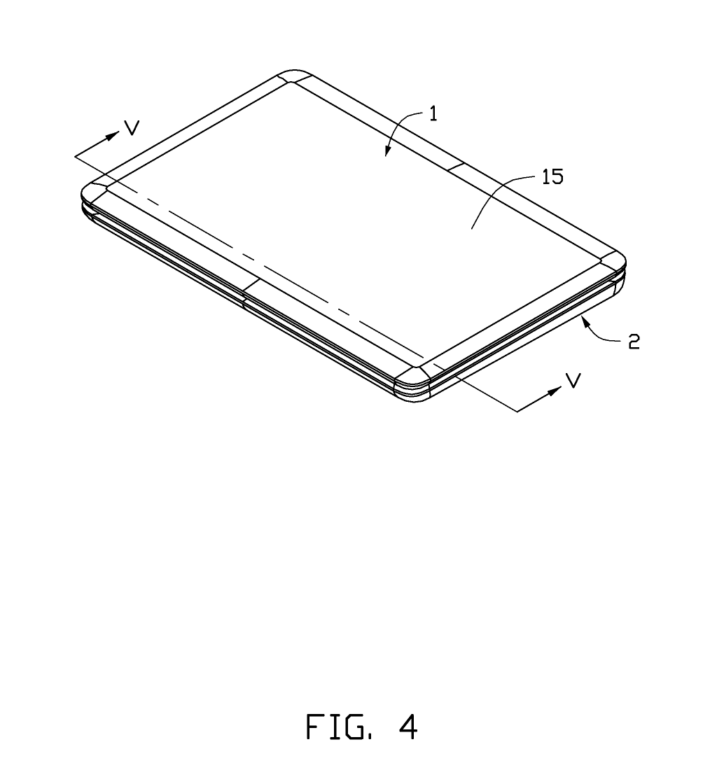

The cover 1 is rotatable relative to the base 2 and can be in a closed position (see FIG. 4), a middle position (see FIG. 3), or an open position (see FIG. 2). In the closed position, the first second magnetic members 12 and the second magnetic members 22 attract each other. A magnetic force between the first magnetic members 12 and the second magnetic members 22 is greater than a resilient force of the resilient members 30, so that the cover 1 stays in the closed position. In the middle position, a critical angle β is defined between the cover 1 and the base 2. In the middle position, the magnetic force between the first magnetic members 12 and the second magnetic members 22 is substantially equal to the resilient force of the resilient members 30. In one embodiment, the critical angel β is less than 45°. In the open position, an angle larger than the critical angel β is defined between the cover 1 and the base 2, and the magnetic force between the first magnetic members 12 and the second magnetic members 22 is less than the resilient force of the resilient members 30.

To rotate the cover 1 from the closed position to the open position, the cover 1 is rotated away from the base 2 by hand to move the first magnetic members 12 away from the second magnetic members 22. When the cover 1 is rotated past the middle position, the magnetic force between the first magnetic members 12 and the second magnetic members 22 is less than the resilient force of the resilient members 30. Thus, the cover 1 is rotated into the open position automatically by the resilient force of the resilient members 30 once the cover 1 is rotated by hand past the middle position.

To rotate the cover 1 from the open position to the closed position, the cover 1 is rotated toward the base 2 by hand. When the cover 1 is rotated past the middle position, the magnetic force between the first magnetic members 12 and the second magnetic members 22 is greater than the resilient force of the resilient members 30. Thus, the cover 1 is rotated into the closed position automatically by the magnetic force between the first magnetic members 12 and the second magnetic members 22 once the cover 1 is rotated by hand past the middle position.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device comprising:
a base;
a cover rotatably attached to the base; the cover comprising a first magnetic member; the base comprising a second magnetic member; and a magnetic force is defined between the first magnetic member and the second magnetic member; and
a resilient member located between the cover and the base;
wherein a critical angle is defined between an inner surface of the cover and a top surface of the base, when a first angle defined between the inner surface of the cover and the top surface of the base is greater than the critical angle, the cover is rotatable relative to the base to be opened by rebounding of the resilient member, and when a second angle defined the inner surface of the cover and the top surface of the base is less than the critical angle, the cover is rotatable relative to the base to be closed by the magnetic force and resiliently deforms the resilient member.

2. The electronic device of claim 1, wherein when the first angle is greater than the critical angle, the magnetic force defined between the first magnetic member and the second magnetic member is less than a resilience of the resilient member; and when the second angle is less than the critical angle, the magnetic force defined between the first magnetic member and the second magnetic member is greater than the resilience of the resilient member.

3. The electronic device of claim 1, wherein the critical angle is less than 45 degrees.

4. The electronic device of claim 1, wherein the cover further comprises a mounting portion, a mounting post extends from the mounting portion and secured to the base, and the resilient member is secured to the mounting post.

5. The electronic device of claim 4, wherein the base further comprises two securing holes, the mounting post is engaged in the two securing holes, and the resilient member is located between the two securing holes.

6. The electronic device of claim 1, wherein the base further comprises a top surface, and an axis of the resilient member is substantially parallel to the top surface.

7. The electronic device of claim 1, wherein the top surface defines a receiving hole, and the second magnetic member is received in the receiving hole.

8. The electronic device of claim 1, wherein the resilient member is a coil spring.

9. An electronic device comprising:
a base;
a cover rotatably attached to the base; the cover comprising a first magnetic member; the base comprising a second magnetic member; and a magnetic force is defined between the first magnetic member and the second magnetic member; and
a resilient member located between the cover and the base;
wherein the cover is rotatable relative to the base and is located on a closed position, a middle position, or an open position; in the closed position, the first second magnetic member and the second magnetic member attract to each other, and the cover is covered on the base; in the middle position, the first magnetic member is removed from the second magnetic member, a critical angle is defined between an inner surface of the cover and a top surface of the base; in the open position, the first magnetic member is removed from the second magnetic member, an angle, larger than the critical angel, is defined between the inner surface of the cover and the top surface of the base.

10. The electronic device of claim 9, wherein when the cover is located in the closed position, the magnetic force is greater than a resilience of the resilient members, when the cover is located in the middle position, the magnetic force is substantially equal to the resilience of the resilient members, and when the cover is located in the open position, the magnetic force is less than the resilience.

11. The electronic device of claim 9, wherein the critical angle is less than 45 degree.

12. The electronic device of claim 9, wherein the cover further comprises a mounting portion, a mounting post extends from the mounting portion and secured to the base, and the resilient member is secured to the mounting post.

13. The electronic device of claim 12, wherein the base further comprises two securing holes, the mounting post is engaged in the two securing holes, and the resilient member is located between the two securing holes.

14. The electronic device of claim 9, wherein the base further comprises a top surface, and an axis of the resilient member is substantially parallel to the top surface.

15. The electronic device of claim 14, wherein the top surface defines a receiving hole, and the second magnetic member is received in the receiving hole.

16. The electronic device of claim 9, wherein the resilient member is a coil spring.
